(19) United States
(12) Patent Application Publication
(10) Pub. No.: US 2019/0163429 A1
(43) Pub. Date: May 30, 2019

(54) TRAFFIC AND PEDESTRIAN ELECTRONIC DISPLAY INTERFACE SYSTEM AND METHOD

(71) Applicant: Alber Hot, Holmdel, NJ (US)

(72) Inventor: Alber Hot, Holmdel, NJ (US)

(21) Appl. No.: 16/196,830

(22) Filed: Nov. 20, 2018

Related U.S. Application Data
(63) Continuation-in-part of application No. 13/038,113, filed on Mar. 1, 2011, now abandoned.
Application No. 13/038,113 is a continuation-in-part of application No. 12/902,781, filed on Oct. 12, 2010, now abandoned.

(51) Int. Cl. G06F 3/147; G06Q 30/02

(52) U.S. Cl. CPC G06F 3/147; G08G 1/07; G06Q 30/0261

(57) ABSTRACT

A method and system for safely providing electronic advertising to pedestrians and vehicle occupants in several regions proximate a controlled traffic intersection.

### CROSS-REFERENCE TO RELATED APPLICATION

This application is a continuation-in-part of U.S. patent application Ser. No. 13/038,113, filed on Mar. 1, 2011, entitled TRAFFIC LIGHT ELECTRONIC DISPLAY INTERFACE SYSTEM AND METHOD, which is a continuation-in-part of abandoned U.S. patent application Ser. No. 12/902,781, filed on Oct. 12, 2010, entitled TRAFFIC-LIGHT ELECTRONIC DISPLAY INTERFACE SYSTEM AND METHOD, which applications are incorporated herein by reference.

### FIELD OF THE INVENTION

The invention relates to the field of electronic advertising systems and, more particularly, electronic advertising systems targeting viewers at controlled traffic intersections

### BACKGROUND OF THE INVENTION

Advertising has become ubiquitous throughout the world in both print form and electronic form. While advertisers seek to convey their message to their target audience, that audience is becoming harder to reach as opportunities for advertising diminish. Advertising in public spaces is necessarily constrained by individual and public safety concerns.

### BRIEF SUMMARY

Various deficiencies of the prior art are addressed by the present invention of methods and systems for safely providing electronic advertising to vehicle occupants in several regions proximate a controlled traffic intersection.

In one embodiment, an Electronic Display Interface (EDI) apparatus for use at a controlled intersection comprises a first display device visually aligned with a first region proximate a corresponding traffic light; a second display device visually aligned with a second region proximate the corresponding traffic light; and a controller, operative to cause the presentation of imagery upon one or both of the first and second display devices when a corresponding traffic light is in a stop state of operation and vehicles facing the traffic light have stopped moving.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a traffic signal control system using an electronic display interface (EDI) according to one embodiment;

FIG. 2 depicts a flow diagram of an advertising synchronization method according to one embodiment;

FIGS. 3-4 depict display system installations proximate traffic lights according to several embodiments;

FIG. 5 depicts a system according to one embodiment;

FIG. 6 depicts a graphical representation of a multiple display device embodiment;

FIG. 7 depicts a high-level block diagram of a system according to one embodiment;

FIG. 8 depicts a high-level block diagram of a computer suitable for use in performing various functions described herein;

FIG. 9 depicts a cross-section view of a sidewalk portion according to an embodiment; and

FIG. 10 depicts a graphical representation of multiple display device embodiment including pedestrian advertising sidewalk panels.

To facilitate understanding, identical reference numerals have been used, where possible, to designate identical elements that are common to the figures.

### DETAILED DESCRIPTION OF THE INVENTION

Embodiments of the present invention will be primarily described within the context of a controlled traffic intersection wherein traffic lights pointing toward drivers signal that the drivers should stop (red light), prepared to stop (yellow light) or proceed through the intersection (green light). The traffic lights made the controlled by a timer, sensors buried in the road (e.g., magnetic sensors to detect the presence of vehicle), sensors mounted nearby (radar or acoustic detectors) or any of the other known mechanisms for controlling traffic lights.

In one embodiment, an Electronic Display Interface (EDI) is coupled to a traffic light. The power source associated with the traffic light is used to power the EDI; optionally, the EDI is associated with power backup schemes such as an uninterrupted power supply (UPS) to maintain power in the event of power glitches and the like. The EDI may comprise a local controller adapted to control the various functions associated with a single intersection. Alternatively, the EDI may comprise a centralized controller adapted to control the various functions associated with multiple intersections.

In one embodiment, a hierarchical control arrangement of EDI is contemplated wherein relevant advertising is sequentially provided to the same one or more vehicles as they traverse intersections. That is, given a sequence of traffic lights such as might exist on a stretch of road in a city, each display device viewed by a vehicle occupant of the vehicle traverses the intersections may be used to provide advertising or other content specifically adapted to augment the advertising or other content previously provided (i.e. fire prior intersections traversed by the vehicle).

The EDI controls one or more display devices such as LCD displays, plasma displays, LCD displays and the like mounted proximate the traffic lights in view of oncoming traffic. In an intersection comprising North-South as well as East-West traffic, respective North, South, East and West display devices may be controlled by the EDI. Generally speaking, the EDI causes the display of advertising, public interest messages and the like on the one or more display devices associated with traffic that is stopped.

The advertising content or public interest messages may comprise still or moving imagery and, optionally, audio information (such as associated with the still or moving imagery, or simply instructive such as for blind pedestrians and the like). In one embodiment, the audio information is transmitted using amplitude modulation (AM), frequency modulation (FM), Bluetooth, 802.11, WiMAX or some other transmission means suitable for use in a motor vehicle.

Advertising content, public interest content and the like are periodically refreshed depending upon the desires of advertisers, government officials and the like. Content may be refreshed via a satellite network, a cellular telephone network, a hardwired/optical network and the like.

In one embodiment, the display devices comprise relatively light weight flat screen monitors mounted next to the traffic light such that there is no height/clearance issue for passing vehicles. The EDI would be programmed and loaded with data via either the cable and/or satellite connection. There would be instantaneous access to all of the locations; in case of an emergency this may save lives.

In one embodiment, the EDI includes equipment suitable for generating a wireless or Wi-Fi hotspot. The Wi-Fi hotspot may comprise an 802.11 or WiMAX hotspot. Other communications technologies may also be employed to provide this function. In one embodiment, each of the hotspots has sufficient range to overlap a neighboring hotspot such that continuous network capabilities are provided to users.

In one embodiment, the hotspot functionality is utilized by control systems within vehicles to help guide the vehicles around traffic jams, help maintain appropriate vehicle spacing and the like. In various modifications of this embodiment, these vehicle control systems utilize information provided by the hotspot to avoid collisions with other cars/pedestrians, to avoid driving the wrong way on one-way streets, to allow automatic engine shutoff such as in the case of a stolen vehicle or operation of vehicle by an intoxicated person and so on.

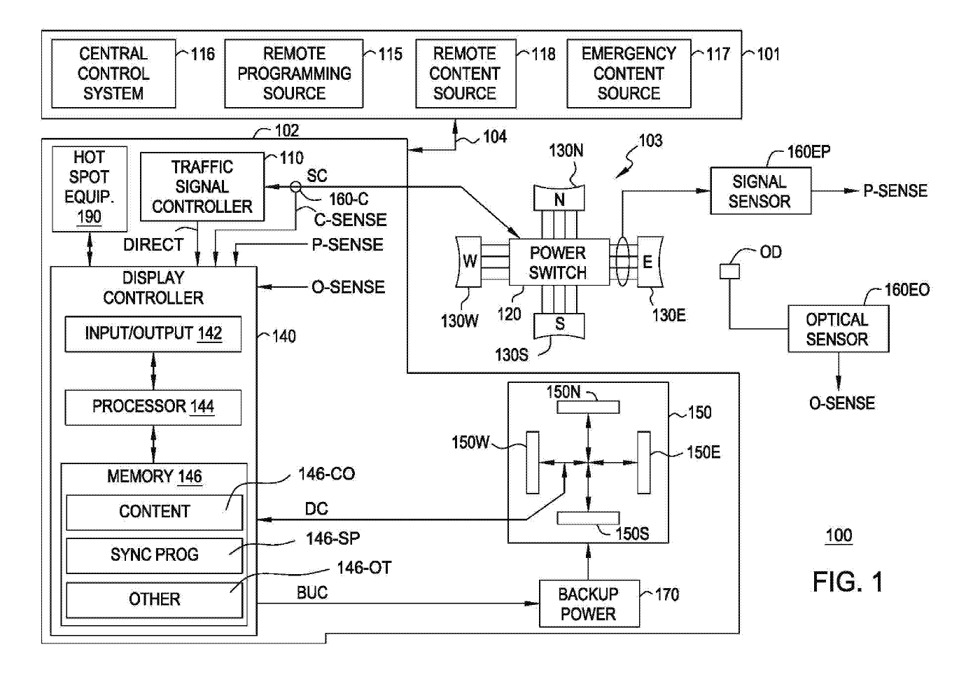

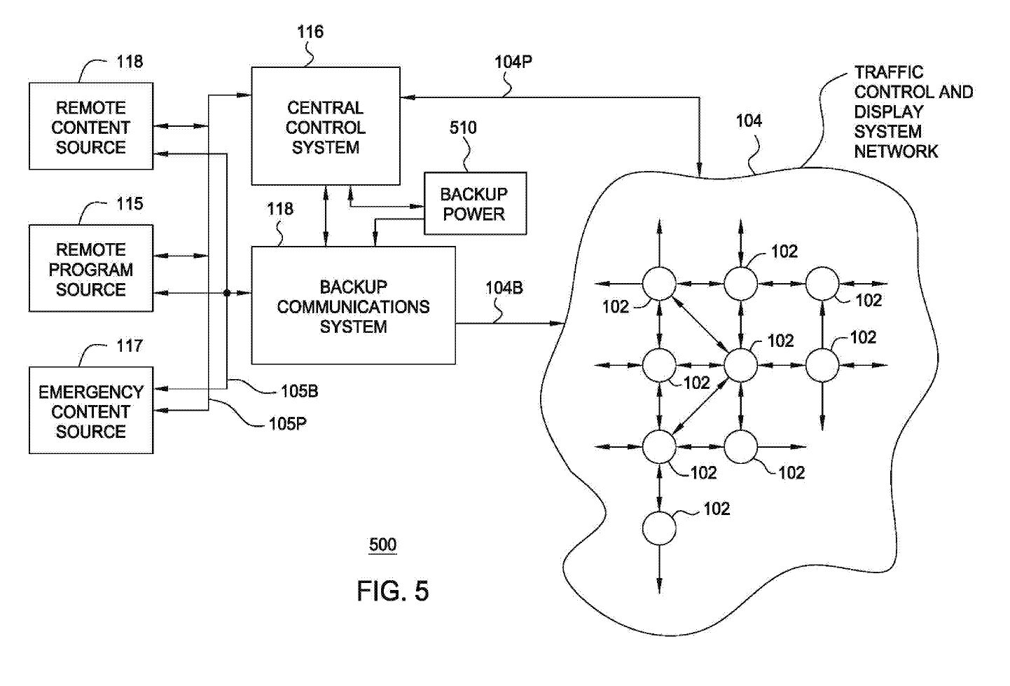

FIG. 1 depicts a high level block diagram of a traffic control system according to one embodiment. Specifically, the traffic control system 100 of FIG. 1 includes a remote or centralized source of control, programming and/or content information 101 in communication with a local EDI 102 via a communications network 104. The local EDI 102 is synchronized in operation with a local traffic signal 103 to provide thereby local advertising and/or other information to drivers proximate the local traffic signal 103. Additional details pertaining to a centralized traffic control systems communicating with multiple local traffic signals and corresponding Edits will be discussed in more detail low with respect to FIG. 5.

The remote or centralized source of control, programming and/or content information 101 comprises a centralized computing system such as a traffic management system centrally located within a city and controlling the traffic lights within that city. Various portions of the centralized source 101 may be implemented at a single traffic management site or via multiple sites operating in a coordinated manner to provide the functionality described herein.

The remote or centralized source of control, programming and/or content information 101 includes one or more of a central control system 116, a remote programming source 115, a remote content source 118 and an emergency content source 117. The functional elements communicating with the local EDI 102 via a communications network 104, which may comprise a wireless network, wired network, Ethernet network, control loop network and the like.

The functional elements of the local EDI 102 and local traffic signal 103 will be described and explained together. The primary functions of the local EDI 102 are implemented by a traffic signal controller 110 which communicates with and controls the operation of the local traffic signal 103, and a display controller 140 which communicates with and controls the operation of a plurality of displays 150. The local EDI 102 is for the depicted as including hotspot equipment 190, the power backup system 170 and various other elements.

The local traffic signal 103 comprises a plurality of traffic signals or traffic lights 130 (illustratively for traffic lights for respective North, South, East and West lanes of a traffic intersection). The traffic lights 130 are illuminated using power derived from a power switch 120 which is controlled via a control signal SC provided by the traffic signal controller 110. The control signal SC indicates the appropriate state for each of the traffic lights 130 (e.g., red, yellow or green). Typically, the traffic signal controller 110 provides a relatively low voltage/low-power signal to the power switch 120. The power switch 120 provides a higher power signal used to drive the lighting elements within the traffic lights 130, such as incandescent lights, LEDs and the like. The traffic signal controller 110 and power switch 120 may comprise separate functional elements or may be included within the same functional element. The functional elements may be mounted on or near polls used to mount the traffic lights 130.

The external or remote programming source 115 is used to provide updated signaling or sequencing information to the traffic signal controller 110 such that the timing or other operations associated with the control of the respective intersection may be changed. Such changes may occur, example, within the context of managing a plurality of intersections in an urban area to optimize traffic flow at different times of the day.

Various modifications may be made to the traffic control system 100, such as to include more or fewer traffic lights, other types of indications such as colored arrows and the like as is well known to those skilled in the art. Generally speaking, any type of traffic control arrangement or topology may be used within the context of the present invention.

The traffic control system 100 is augmented by, in one embodiment, an Electronic Display Interface (EDI) 102 comprising the display controller 140, the plurality of displays 150, means for sensing a change in traffic light states 160, optional power backup system 170, optional remote content source 118 and optional hot spot (network) equipment 190 suitable for generating or communicatively supporting a wireless network or Wi-Fi hotspot such as an 802.11 or WiMAX hotspot.

The display controller 140 is depicted as a computing architecture or computing element suitable for use in performing the functions described herein. In one embodiment, the display controller 140 comprises various cooperating elements, including a processor element 3144 (e.g., a central processing unit (CPU) and/or other suitable processor(s)), a memory 146 (e.g., random access memory (RAM), read only memory (ROM), and the like) and various input/output devices 142 (e.g., a user input device (such as a keyboard, a keypad, a mouse, and the like), a user output device (such as a display, a speaker, and the like), an input port, an output port, a receiver/transmitter (e.g., an air card or other suitable type of receiver/transmitter), and storage devices (e.g., a hard disk drive, a compact disk drive, an optical disk drive, and the like)).

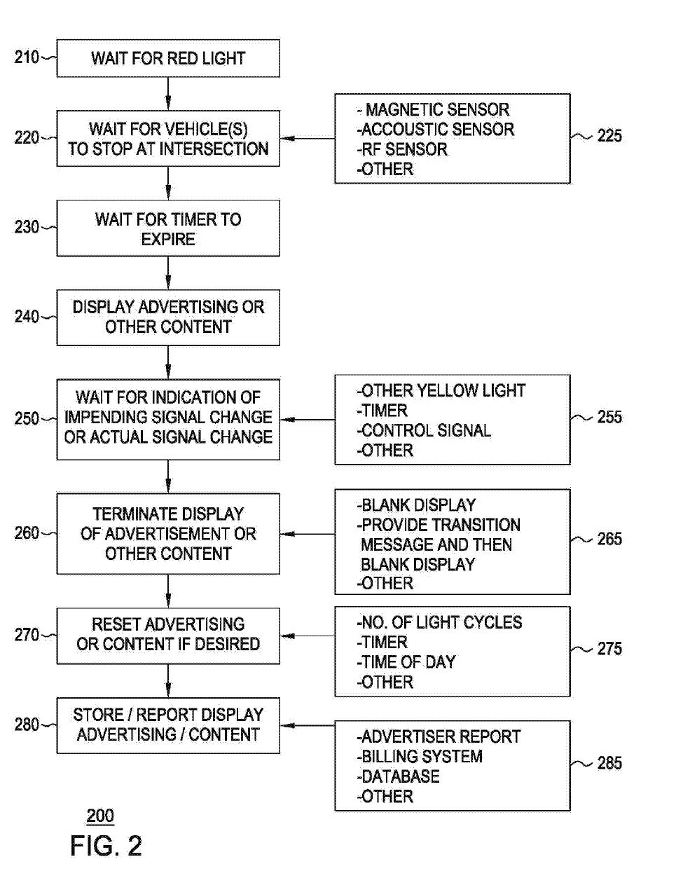

The display controller 140 communicates imagery representative video and/or data signals to the displays 150 via a control signal DC. Advertising or other content associated with the imagery is stored, in one embodiment, a content storage portion 146-CO of the memory 146 of display controller 140. The memory 146 stores software instructions which, when executed, perform various method according to the embodiments such as a synchronization program 146-SP which will be described more detail below with respect to FIG. 2, as well as other programs 146-OT.

The plurality of displays 150 comprise, illustratively, four displays denoted as 150N, 150S, 150E and 150W which are physically mounted proximate to corresponding traffic lights 130N, 130S, 130E and 130W. Each of the displays 150 is aligned with its corresponding traffic light 130 such that a vehicle in intersections viewing a particular traffic light 130 may also readily view the corresponding display 150.

While not shown, it will be appreciated that each of the displays 150 is capable of presenting or generating visual imagery in response to a video or data signal representing such imagery. Moreover, each of the displays 150 includes the appropriate hardware/software/circuitry necessary to power the display and render the visual imagery in response to the video or data signals presented thereto.

As previously noted, and as described in more detail below with respect to FIG. 2, the display controller 140 causes the displays 150 to present advertising or other content to vehicles at a controlled intersection. The presentation of this imagery and optional audio information occurs only during the time period within which the vehicle is stopped at the traffic light. To determine when the traffic lights are red, yellow or green states it is necessary to provide this information to the display controller 140. Various embodiments utilize different techniques to provide this information to the display controller 140.

In one embodiment, traffic light state information is provided to the display controller 140 directly from the traffic signal controller 110.

In another embodiment, a control signal sensor 160C senses the control signal SC provided to the power switch 120 by the traffic signal controller 110 and responsively provides a corresponding signal C-SENSE to the display controller 140.

In another embodiment, one or more power signal sensors 160xP sense the driver signals provided by the power switch 120 to the various traffic lights 130 and responsively provide a corresponding signal P-SENSE to the display controller 140. For simplicity, FIG. 1 depicts only a single power signal sensor 160EP associated with an East facing traffic light 130E. However, it will be appreciated that additional power signal sensors 160WP, 160NP and 160SP may be mounted on corresponding traffic lights 130W, 130N and 130S.

In another embodiment, one or more optical signal sensors 160xO sense the optical output or light provided by the traffic lights 130 and responsively provide a corresponding signal O-SENSE to the display controller 140. For simplicity, FIG. 1 depicts only one optical detector OD and signal sensor 160EO and associated with an East facing traffic light 130E. However, it will be appreciated that additional optical detectors OD and signal sensors 160WO, 160NO and 160SO may be mounted on corresponding traffic lights 130W, 130N and 130S. In various embodiments, one optical detector OD is associated with some or all of the lights provided by a single traffic light 130 (e.g., red, yellow, green, green arrow, red arrow and so on).

The optional power backup 170 operates to keep the displays 150 illuminated in case of a power outage. In various embodiments, the backup function may be provided by a power backup source (not shown) utilized by the power switch 120 is part of the normal power backup system associated with traffic control system 100.

The remote content source 180 comprises a server or other content repository accessed by the display controller 140 using a network connection, such as a cellular telephone network, satellite network and the like. The display controller 140 is associated with or otherwise includes circuitry and software adapted to communicate with the remote content source 180 by whichever network is appropriate. Content retrieved from the remote content source 180 is stored in the content portion 146-CO of the memory 146 of the display controller 140.

The network equipment 190 suitable for generating or communicatively supporting a wireless network or Wi-Fi hotspot such as an 802.11 or WiMAX hotspot may comprise a router or other network communications device capable of performing this function. The network equipment 190 may be integrated with the display controller 140 or may be a separate unit.

The network equipment 190 provides network accessibility to vehicles within a predefined range depending upon the network technology used. In various embodiments, the network equipment 190 is connected to a cellular telephone network or other access network to provide Internet access to vehicles, the communications or network link between the display controller 140 and the remote content source 180, a communications are network link between a traffic signal controller 110 and corresponding remote programming source 115 and so on. Generally speaking, the network equipment 190 may be used for many purposes.

In one embodiment, network equipment 190 at each of a sequence of controlled traffic intersections is used to communicate messages between display controllers 140 at the various control traffic intersections such that a coherent sequence of advertising or other content may be provided to vehicles traversing the multiple traffic intersections. The coherent sequence of advertising or other content may comprise, illustratively, portions of a relatively long advertisement, different advertisements (i.e., ensure that the same advertisement is not repetitively seen by the vehicle occupant), different content and so on. Additionally, public service messages may change based upon where the vehicles located such as in the case of traffic jams near particular control traffic intersections.

In one embodiment, an emergency override is provided wherein government entities may cause specific content to be displayed on any display device and at any time, irrespective of the state of the traffic signals.

The content used for advertising presentation and the like is periodically changed based upon agreements with advertisers, local government entities and the like. The content may comprise advertising, public service messages, traffic information and the like.

In one embodiment, an advertiser contracts with the EDI owner to present specific advertising or other content for a predetermined number of traffic light cycles, predetermined number of stopped vehicles, predetermined amount of time, during a predetermined time of day and/or any combination thereof. The EDI owner tracks the presentation of this advertising or other content and stores the tracking data in memory. The tracking data is then provided to the advertiser as part of a tracking report for billing report. The advertiser pays the EDI owner based upon the agreed-upon terms of the contract.

In one embodiment, advertisers may change at any time the specific advertisements presented at intersections on their behalf. In this embodiment, new advertisements or other content are pushed to the EDI owner for subsequent updating of the display controller 140 associate with the one or more contracted controlled traffic intersections. In other embodiments, the EDI owner pulls updated advertisements or other content from the advertiser or other content provider periodically, after predefined number of presentations, in response to changes in the time of day and so on.

In one embodiment, the various technologies are used to count the number of cars stopped at an intersection. In this manner, the number of vehicles having occupants able to is viewed a particular advertisement may be tracked and provided to advertisers or other content providers.

Revenues generated by the EDI owner due to contractual arrangements with advertisers or other content providers may be shared with local municipalities or other government entities to help fund their operations, defray the cost of road maintenance and so on. Generally speaking, various embodiments of the invention provide a mechanism wherein advertising revenue may be generated based upon the safe use of public transportation signaling infrastructure.

FIG. 2 depicts a flow diagram of an advertising synchronization method according to one embodiment. Specifically, the method 200 of FIG. 2 is suitable for execution by the display controller 140, such as via software instructions stored within the memory 146 which are executed by the processor 144 to perform the various steps discussed herein. It is noted that the method 200 described herein with respect to FIG. 2 is related to the operation of a single display 150. For intersection with four displays associated with four corresponding traffic lights, the method 200 of FIG. 2 is modified to perform the same basic functions for each of the four displays to synchronize display operation to respective traffic light operations.

At step 210, the method waits for the traffic light to achieve a red light state or condition. As previously noted, this condition may be sensed via various means 160, which means convey the information to the display controller 140.

At optional step 220, the method waits for one or more vehicles at the intersection portion facing the display to stop. As noted in box 225, this determination may be made with respect to magnetic sensors embedded in the road that detect vehicles, acoustic sensors and/or RF sensors that detect vehicles and other techniques. While not shown in the various drawings, such sensors are known to those skilled in the art and currently used in controlled intersections.

At optional step 230, the method waits for a timer to expire. The expiration of the timer may allow time for cars approaching the intersection to come to a complete stop.

Steps 220 and 230 are designed to provide time in which a moving vehicle may come to a stop such that the initiation of advertising or other content display on the display device, to strike the driver of a moving vehicle. The steps are used in various embodiments, but not all embodiments.

At step 240, the method begins displaying advertising or other content on the display device.

At step 250, the method waits for an indication of an impending signal change or actual signal change. In one embodiment, the advertising or other content display initiated at step 240 terminates when the traffic light of interest changes from red to green (i.e., an actual signal change). In another embodiment, the advertising or other content display initiated at step 240 terminates prior to the traffic light of interest changing from red to green. For example, referring to box 255, the method waits for an indication of a yellow light at another traffic light (i.e., without yellow light will be followed by a red light at the traffic light of immediate interest), the expiration of a timer, the change in a control signal such as provided by the traffic signal controller 110 or some other indication of impending signal change.

At step 260, the method terminates the display of the advertisement or other content. Referring to box 265, the termination of the displayed imagery may be accomplished by blanking or turning off the display device, providing a transition message to the vehicle occupant and then blanking the display or some other means.

At optional step 280, data associated with the display of advertising or other content is stored in memory or otherwise reported to an entity tracking the display of such advertising or other content. For example, in various embodiments in particular advertiser may pay each time their advertisement is displayed. In addition, the payment of the advertiser may depend upon the number of vehicles that view the display (i.e., the number of vehicles stopped in front of the traffic light of interest). The number of vehicles stopped in front of the traffic light of interest may be determined by various means, such as the mechanisms discussed above with respect to box 225.

It should be noted that functions depicted and described herein may be implemented in software and/or in a combination of software and hardware, e.g., using a general purpose computer, one or more application specific integrated circuits (ASIC), and/or any other hardware equivalents. In one embodiment, software implementing methodology or mechanisms supporting the various embodiments is loaded into memory 146 and executed by processor(s) 144 to implement the functions as discussed herein. Thus, various methodologies and functions (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible fixed or removable media, transmitted via a data stream in a tangible or intangible broadcast or other signal bearing medium, and/or stored within a memory within a computing device operating according to the instructions.

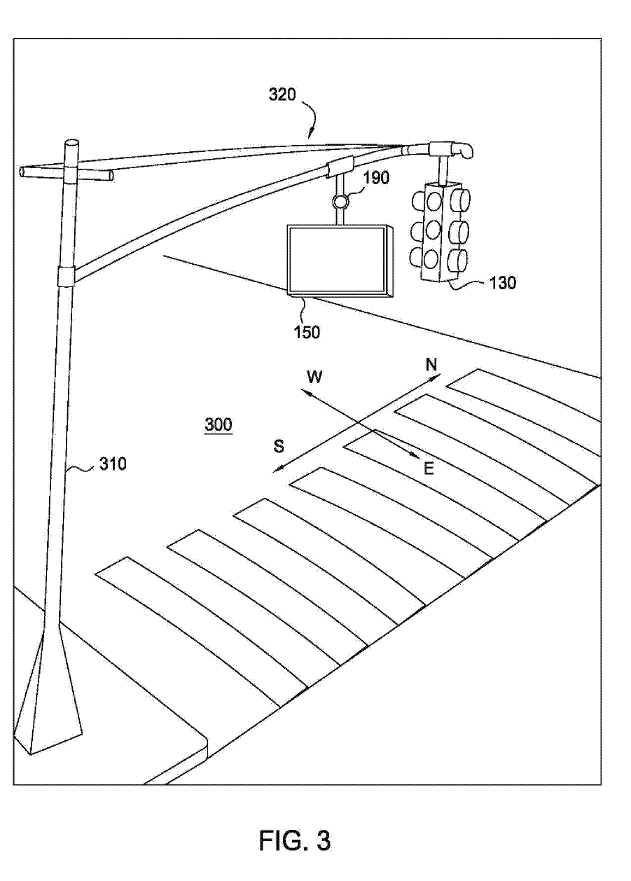

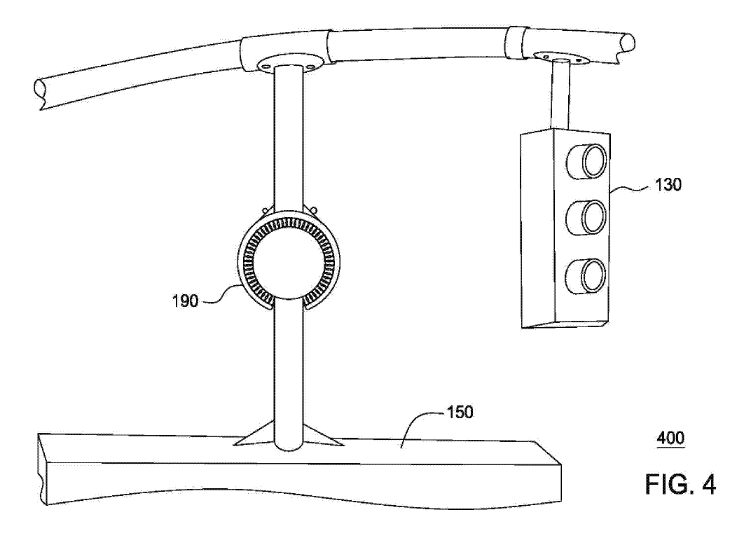

FIGS. 3-4 depict display system installations proximate traffic lights according to several embodiments. Specifically, FIGS. 3-4 depict an intersection 300 in which a poll 310 supports a cross-member 320 from which a traffic light 130, display 150 and network equipment 190 are secured. It is noted that a single traffic light 130 and single display 150 are shown; however, as will be appreciated there may be multiple traffic lights and multiple displays provided in this manner.

FIG. 5 depicts a system according to one embodiment. Specifically, the system 500 of FIG. 5 comprises a central control system 116 in communication via a primary communication channel 105P with a remote content source 118, a remote program source 115, an emergency content source 117, a backup communication system 118 and a backup power source 510.

The central control system 116 communicates with a plurality of local traffic control systems (depicted as the EDI portion 102 of a traffic control system 100) via a primary network 104P to provide thereby the various control functions previously described with respect to FIG. 1. It is noted that the EDI portions 102 of local traffic control systems 100 are depicted as forming respective nodes or network elements within a traffic control and display system network 104. While these nodes or network elements are depicted in FIG. 5 as forming a mesh network, it will be appreciated by those skilled in the art that other network topologies may be employed within the teachings of the invention.

The central control system 116 communicates advertising content, traffic light sequencing information, emergency service content, Amber alert messages, service/status information and the like to the local traffic control systems 100 via the primary network 104P. The central control system 116 may also receive status messages from the local traffic control system 100 via the primary network 104P.

The backup communication system 118 is adapted to communicate necessary information to the local traffic control systems 100 via a backup network 104B. The backup communication system 118 communicates via a backup communication channel 105B with the remote content source 118, the remote program source 115, the emergency content source 117, the central control system 116 and the backup power source 510.

The backup communication system 118, backup communication channel 105B and backup network 104B may be implemented using a redundant technology similar to the corresponding primary functions or using an entirely different technology. In one embodiment, the backup communication system 118 utilizes a satellite-based communication system to communicate with the remote content source 118, the program source 115 and/or emergency content source 117. In one embodiment, the backup communication system 118 interacts with the emergency content source 117 and not the remote content 118 and program 115 sources. In one embodiment, the backup network 104B comprises a cellular telephone network while the primary network 104P comprises a hardwired optical or electrical network.

Various modifications to the embodiment described above are also contemplated by the inventor, including modifications of the embodiments described below. Generally speaking, various embodiments described above may be modified in accordance with the embodiments described below in any combination.

### Additional Display Devices

Depending upon the type of display device technology used for a traffic light display device, only the occupants of the first few vehicles waiting at a traffic light can actually view the display device mounted proximate the traffic light (e.g., occupants of the first five or six vehicles).

One embodiment contemplates additional display devices adapted to display advertising or other imagery to the occupants of vehicles which are too far away from the display device mounted at the traffic light. The additional display devices are mounted on utility poles, signposts and the like leading up to or approaching an intersection including traffic light displays such as described above.

In one embodiment, additional vehicle sensors are also mounted proximate the additional display devices. These additional sensors are used to determine when traffic proximate the additional display devices has stopped moving. In this embodiment, the display of advertising imagery or other information at an additional display device is avoided until such time as the vehicles near the additional display device have stopped moving.

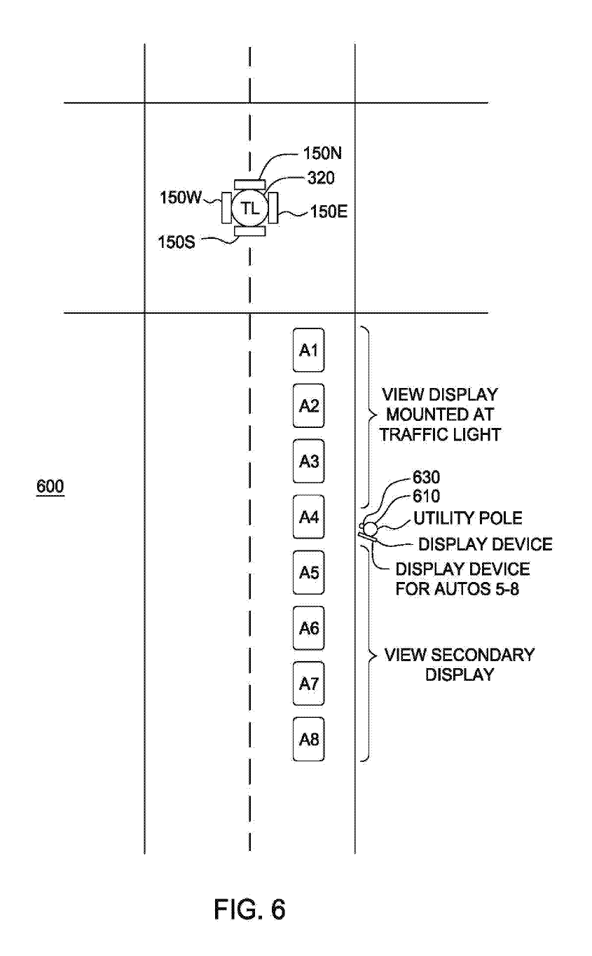

FIG. 6 depicts a graphical representation of a multiple display device embodiment. Specifically, the graphical representation 600 depicts a traffic light 320 controlling a four-way intersection (i.e., North, South, East, West) in which each traffic lane is associated with a respective first display device 150. The first display device 150 provides the advertising and/or other imagery to vehicles substantially as described above. A utility pole 610 having mounted thereon a display device 620 provides an additional display device for conveying advertising and/or other imagery to traffic approaching the intersection.

In particular, a plurality of automobiles denoted as automobiles A1 through A8 are depicted as stopped in front of the traffic light 320. The first four automobiles A1-A4 are close enough to the first display device 150S to view imagery presented thereon, while the second four automobiles A5-A8 are close enough to the additional display device 620 to view imagery presented thereon. The imagery presented by display devices 150S and 620 may comprise the same imagery for different imagery.

Optionally, the utility pole 610 may also have mounted thereon various sensors 630 for monitoring the lane to identify the presence or absence of vehicles, whether or not vehicles are moving, characteristics associated with any vehicles and so on as described herein. The utility pole 610 may also have mounted thereon various networking equipment (not shown) as discussed herein. Moreover, rather than a utility pole the display device 620, sensors 630 and/or other equipment may be mounted on traffic poles, special-purpose mountings, buildings and the like. In one embodiment, such mounting is over the road surface and provided via wires or other structure.

Generally speaking, each display device is adapted to display imagery to vehicles occupying a respective region. A first or main display device mounted proximate the traffic light may provide imagery to a first region in front of the traffic light, such as a region occupied by a first plurality of vehicles. Similarly, a second or auxiliary display device mounted on a utility pole may provide imagery to a second region, such as a region occupied by a second plurality of vehicles. The size of the region associated with the display device is related to the size of the display device itself and the ability of that display device to be viewed by vehicles within the region. The regions and/or vehicles associated with the regions may overlap such that each vehicle may view two or more display devices.

Various embodiments provide imagery for more that the depicted two regions. Various embodiments use more than one display device for one or more of the regions.

### Targeted Advertising

In various embodiments, advertising is targeted at the occupants of vehicles where useful information associated with the occupants is available, such as the identity of the occupants, the type of vehicle the occupants are driving and/or any other information useful in targeting advertising.

In one embodiment, demographic or identification information associated with a vehicle and/or occupants of the vehicle is determined. The determined demographic or identification information is used to select specific advertising imagery to be presented to the occupants of the vehicle.

In one embodiment, a license plate scanner is used to identify the license plate associated with a vehicle and responsively retrieve any available information associated with the scanned license plate. Retrieved information associated with a scanned license plate may include information pertaining to the owner of the vehicle, information pertaining to the make and model of the vehicle, information pertaining to the state of registration of the vehicle and so on. The information may be provided by state departments of motor vehicles, third-party information aggregators and the like.

In one embodiment, optical scanners are used to capture image information associated with the vehicle and/or the occupants of the vehicle. Vehicle related image information is optionally processed to identify the make and/or model of the vehicle. Occupants' related image information may be processed using facial recognition algorithms and the like to identify with specificity one or more occupants within a particular vehicle.

In one embodiment, radiofrequency scanners are used to capture information from the vehicle or its occupants such as from radiofrequency (RF) ID tags, cellular telephone emissions, vehicle wireless network emissions and the like. The captured RF information is processed using an RF data processing engine to extract therefrom information useful in identifying the vehicle and/or the occupants of the vehicle.

Demographic or identification information associated with the vehicle and/or its occupants, from whatever source, may be provided to an advertising selection engine for further processing. In particular, the advertising selection engine uses the provided information to identify or select advertising appropriate to the actual or likely occupants of the vehicle. The advertising selection engine may be implemented locally or via a remote processing entity. Moreover, in various embodiments the advertising selection engine is implemented using a third-party service.

The advertising selected for presentation to the vehicle occupants may comprise still or moving imagery stored at a local database or delivered from a remote database.

In various embodiments, identification information associated with the vehicle and/or its occupants, as well is data indicative of the specific advertisements presented to the vehicle and/or its occupants, is stored in a local or remote database. In this manner, the number of impressions of a particular advertisement with respect to a vehicle and/or vehicle occupant may be tracked. Additionally, by understanding which advertisements have been already provided to the vehicle and/or vehicle occupant, new advertisements may be preferentially presented during subsequent advertising opportunities.

As an example, even if specific license plate data is not available to the system due to privacy or other concerns, the identification of specific unique vehicles within the context of targeted advertising as described above is beneficial. For example, even though the system operator may not know any demographic information associated with a vehicle or its occupants, the system operator will still be able to track how many impressions of each particular advertisement were made with respect to each particular vehicle. This is valuable information from an advertiser's perspective in that the information validates advertising expenditures to advertisers, supports a per-impression billing model for the system operator, provides the basic information useful in tracking advertising programs and the like.

### Smart Box Embodiments

Various embodiments provide for a system in which a plurality of network modules or “smart boxes” are mounted on traffic poles, utility poles and so on such that a multiple node interactive network is formed that is capable of monitoring vehicular traffic at different levels of granularity. For example, to provide basic traffic density reporting functions there is no need to identify with specificity any vehicle or vehicle occupants. For this function, the number of vehicles passing a fixed point is counted over a predetermined period of time. However, to provide more detailed reporting functions is useful to count the number of vehicles and/or vehicle occupants matching certain criteria, whether demographic criteria, vehicle type criteria, or other criteria.

The multiple node interactive network is formed using various radiofrequency, optical, audio and other sensors proximate traffic lights or distributed elsewhere within the road system (e.g., on traffic or utility poles leading up to controlled intersections).

In one embodiment, Internet access is made available using a WiMAX, 802.11, WLAN or other associated technology. In one embodiment, user traffic associated with vehicles and/or vehicle occupants is conveyed via the multiple node interactive networks to an access network router, a satellite transmission system, the fiber-optic transmission system or any other means to provide network services.

In one embodiment, advertising and/or other information is presented to vehicle occupants via display devices within the vehicle. The information for display that is transmitted to the vehicle via the wireless network communicates with networking systems within the vehicle. Generally speaking, information may be uploaded from the vehicle to the various systems described herein and/or downloaded to the vehicle from the various systems described herein. Upload information may include vehicle diagnostics and the like. Moreover, smart phones and other personal communication devices of vehicle occupants may be linked to the wireless networks described herein and/or a wireless network within the vehicle.

In one embodiment, access to various network services is provided as a “free” service in exchange for providing demographic information associated with the vehicle and/or vehicle occupants using the service. In this manner, advertising may be appropriately targeted as described above.

In one embodiment, sound associated with advertising imagery is broadcast via a short-range radio channel (e.g., AM, FM), streaming audio on a specific wireless network address, or other appropriate mechanism. Generally speaking, various embodiments include broadcast equipment adapted to interact with vehicle receiver equipment and provide thereto advertising imagery suitable for presentation within the vehicles, the broadcast equipment using any of a short-range radio channel and/or a wireless network to stream video or audio information to the vehicles.

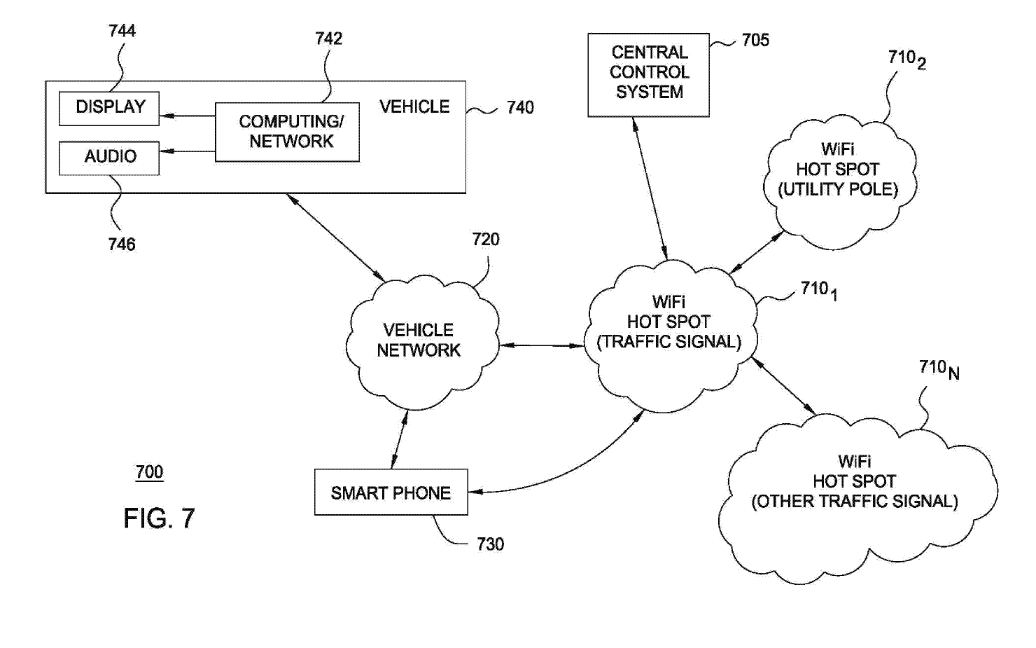

FIG. 7 depicts a high-level block diagram of a system according to one embodiment. Specifically, FIG. 7 depicts a plurality of Wi-Fi networks interacting with each other as well as the vehicle.

The system 100 of FIG. 7 depicts a central control system 705, a plurality of Wi-Fi hotspots 710, a vehicle wireless network 720, a smart phone 730 and a vehicle 740.

The depicted plurality of Wi-Fi hotspots includes a first Wi-Fi hotspot 710₁, such as a hotspot generated by equipment mounted at a traffic signal proximate the vehicle 740. The first Wi-Fi hotspot 710₁ communicates with a second Wi-Fi hotspot 710₂, such as a hotspot generated by equipment mounted at a utility pole. The first Wi-Fi hotspot 710₁ may also communicate with other Wi-Fi hotspots 710_{N}.

The vehicle 740 includes a computing/networking apparatus 742, a display device 744 and an audio device 746. The computing/networking apparatus 742 is operable to perform the various computing and networking functions described herein with respect to the vehicle, such as providing a vehicle network 720 (i.e., a Wi-Fi hotspot within and proximate the vehicle) capable of interacting with the smart phone or other wireless network enabled devices. The display device 744 is operable to display advertising imagery and/or other image information in response to signals received from the computing/networking apparatus 742. The audio device 746 is operable to present advertising audio information and/or other audio information in response to signals received from the computing/networking apparatus 742. The advertising imagery and/or audio information may be provided by a Wi-Fi hotspot associated with a traffic light proximate the vehicle or other means described herein.

The first Wi-Fi hotspot 710₁ is depicted as communicating with the central control system 705 which provides various control functions, advertising update functions, access network functions, edge router functions and the like. Generally speaking, the central control system 705 implements any of the control, access, billing or other functions supporting Internet access via the computing system 742 of the vehicle 740, the smart phone 730 or other network capable devices (not shown). The various Wi-Fi hotspots 710 may communicate with the central control system 705 directly or via intermediary Wi-Fi hotspots.

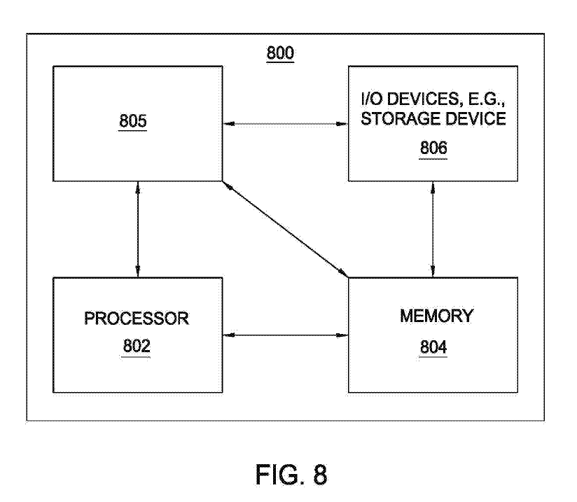

FIG. 8 depicts a high-level block diagram of a computer suitable for use in performing various functions described herein, such as implementing the computing, image processing, data manipulation, network processing, display control and/or other functions or elements of the various embodiments described herein with respect to the various figures.

As depicted in FIG. 8, computer 800 includes a processor element 802 (e.g., a central processing unit (CPU) and/or other suitable processor(s)), a memory 804 (e.g., random access memory (RAM), read only memory (ROM), and the like), a cooperating module/process 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the cooperating process 805 can be loaded into memory 804 and executed by processor 802 to implement the functions as discussed herein. Thus, cooperating process 805 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal-bearing medium, and/or stored within a memory within a computing device operating according to the instructions.

In various embodiments, one or more sensors monitor vehicles in each of the first, second or any additional region such that controlling circuitry knows when vehicles in a region are moving or stationary. In one embodiment, in response to any vehicle moving in any region, the controller inhibits the display of imagery upon any of the display devices. In one embodiment, the controller only inhibits the display of imagery upon display devices in the region with moving vehicles. In one embodiment, the controller only inhibits the display of imagery upon display devices in the region with moving vehicles and any adjacent regions thereto.

In various embodiments, Wi-Fi hotspot equipment is adapted to interact with vehicle networking equipment and provide thereto advertising imagery suitable for presentation within said vehicle. In other embodiments, the Wi-Fi hotspot equipment is further adapted to provide Internet access to vehicle networking equipment. This Internet access is may be provided free, by subscription and/or in exchange for the viewing of advertisements within said vehicle.

In various embodiments, each vehicle is associated with one or more identifiers adapted for use in targeting appropriate advertisements to vehicle occupants.

In various embodiments, image sensors are used to capture image information associated with vehicles and/or vehicle occupants, where the captured image information is further processed to derive identifying characteristics associated with vehicles or vehicle occupants. This processing may be done in whole or in part at or among a local computer/database, a central computer/database and/or via a third party service. The identifying characteristics associated with vehicles or vehicle occupants may be further processed to derive demographic information suitable for use in determining advertisements appropriate for presentation to vehicle occupants.

Various modifications to the embodiment described above are also contemplated by the inventor, including modifications of the embodiments described below. Generally speaking, various embodiments described above may be modified in accordance with the embodiments described below in any combination.

### Pedestrian Advertising

Specifically, the various embodiments described above are primarily described within the context of presentation devices mounted on traffic control devices or supporting structure, signage, street structures and the like, which presentation devices are primarily directed to providing advertising or other content for viewing by drivers and/or passengers within automobiles passing through an intersection. Additional embodiments will now be described with respect to the presentation of advertising or other content for viewing by pedestrians proximate the intersection or street.

Specifically, in some embodiments the presentation devices described above with respect to the various figures are configured to be directed toward pedestrians walking along the sidewalk. These embodiments contemplate some or all of the various techniques described above with respect to the various embodiments wherein one or more of the display devices are configured to be viewable by pedestrians walking the sidewalk such as the sidewalk proximate the intersections described above.

In further embodiments, presentation devices specifically configured for pedestrian viewing of advertiser or other contract are provided. For example, in various embodiments sidewalk portions normally comprising cement slabs and the like are replaced by display panels. The display panels may comprise standard display devices as well as holographic display devices. Further, the display panels may include other functionality such as Wi-Fi hotspot functionality, emergency services functionality, heating abilities (i.e. to melt snow/ice) and the like.

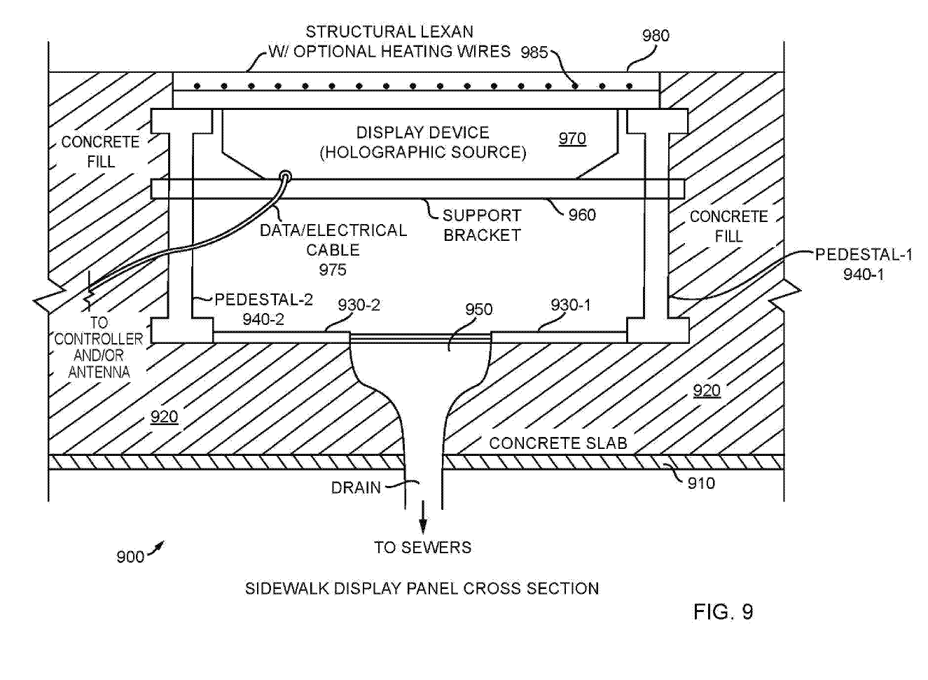

FIG. 9 depicts a cross-section view of a sidewalk portion according to an embodiment. Specific, the cross-section of the with display panel 900 depicted in FIG. 9 comprises, illustratively, a display device 970, such as a LED/LCD or other technology display device capable of flat-panel display, holographic display and the like. The imagery of the display device 970 is visible through a transparent or translucent panel 980, illustratively a panel made of structural glass, polycarbonate, Lexan or other transparent/translucent material, which material forms the surface of the sidewalk upon which the pedestrians walk. Optionally, heating wires 985 are disposed therein to enable temperature stabilization, melting of ice/snow and the like.

The display device 970 may be mounted upon, illustratively, a support bracket 960 which in turn is secured to one or more pedestals 940. As depicted in FIG. 9, an optional drain 950 is disposed below the support bracket 960 and illustratively depicted as connecting with a city sewer system to accommodate thereby any drainage requirements associated with the relevant portion of the sidewalk. In general, the sidewalk is built upon a concrete slab 910 or other base material. As depicted in FIG. 9, concrete so on 20 is disposed around and under the above-described sidewalk portions. As depicted in FIG. 9, the top of pedestals 940 is used to support the transparent or translucent panel 180. It is noted that while two pedestals 940-1 and 940-2 are depicted, more or fewer pedestals may be used. In some embodiments, the pedestals may be formed within the concrete itself.

As depicted in FIG. 9, data/electrical cabling 975 is depicted as connecting the display device 970 to display control circuitry (not shown) such the local and/or remote display control circuitry and systems described above with respect to the various figures. In various embodiments, wireless networking equipment and the like may be included along with the display device 970 to provide additional services to pedestrians such as Wi-Fi hotspot services and the like. Various embodiments, such wireless networking equipment may configured as a mesh network operable to, illustratively, propagate control information among a plurality of sidewalk or traffic light mounted display panels, sidewalk or traffic light mounted control modules and the like.

Various modifications to the sidewalk control panel may be made to accommodate different types of sidewalks, different materials, different viewing angles of the display device 970, different types of display device technologies and so on.

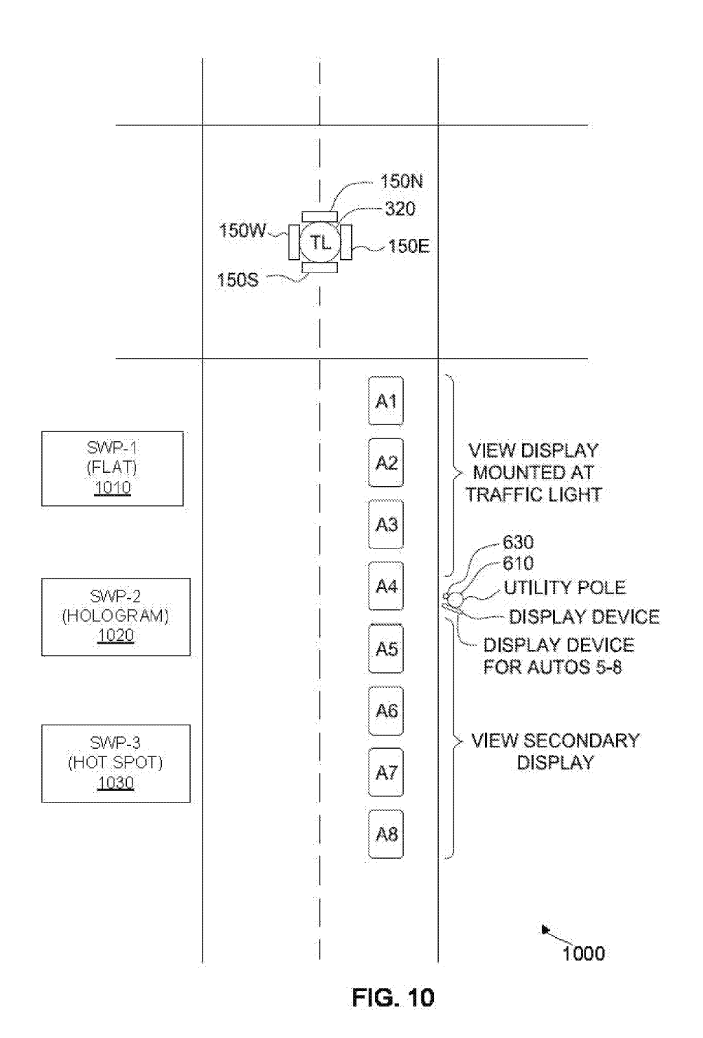

FIG. 10 depicts a graphical representation of multiple display device embodiment including pedestrian advertising sidewalk panels. Specifically, the embodiments of FIG. 10 are similar to those described above with respect to FIG. 6, with the inclusion of sidewalk display panels of various types; namely, a first sidewalk display panel 1010 including a flat display, a second sidewalk display panel including a holographic display, and a third sidewalk display panel 1030 providing hotspot functionality in addition to display functionality.

In various embodiments, each of the sidewalk display panels is of a similar technology and provides a coordinated or sequence advertising or other image-based message to pedestrians in a manner similar to that described above with respect to the embodiments directed to automobile drivers and passengers.

Various embodiments provide an integrated display/advertising mechanism for targeting both pedestrians and vehicle occupants at intersections, at sections of road/sidewalk away from intersections and so on. The various embodiments also provide emergency services information as needed, such as directing traffic or pedestrians in a particular direction to avoid a source of danger.

As with embodiments described above, pedestrian display embodiments may also be configured for use within the context of a controlled intersection wherein advertising is provided to pedestrians when the pedestrians are stopped, such as waiting for a red light to turn green so I can cross the street. Since pedestrians tend to bunch up that intersections there are ample opportunities to provide multiple sidewalk display panels at the district crosswalks and the like, especially a controlled intersections.

In one embodiment, an integrated display apparatus is provided for use at a controlled intersection including a first plurality of display devices configured to be viewed by vehicle occupants, a second plurality of display devices configured to be viewed by pedestrians including display devices within sidewalk panels, and a controller, configured to cause the presentation of imagery upon one or both of the first and second plurality of display devices when a corresponding traffic light is in a stop state of operation and vehicles and pedestrians facing the traffic light have stopped moving. The controller may comprise an electronic display interface system such as previously described.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. An integrated display system for use at a controlled intersection, comprising:
a first plurality of display devices configured to be viewed by vehicle occupants;
a second plurality of display devices configured to be viewed by pedestrians including display devices within sidewalk panels; and
a controller, configured to cause the presentation of imagery upon one or both of the first and second plurality of display devices when a corresponding traffic light is in a stop state of operation such that vehicle occupants and pedestrians within view of the first or second plurality of display devices have stopped moving.

2. The system of claim 1, wherein at least a portion of the second plurality of display devices comprise sidewalk display panels, each sidewalk display panel comprising a substantially transparent top portion having a display device mounted thereunder.

3. The system of claim 2, wherein the display device comprises one of a flat panel display device and a holographic display device.

4. The system of claim 2, wherein at least one of the sidewalk display panels includes wireless networking equipment configured to provide Wi-Fi hotspot services to pedestrians.
